(19) United States
(12) Patent Application Publication
(10) Pub. No.: US 2018/0101136 A1
(43) Pub. Date: Apr. 12, 2018

(54) INTEGRATED TIME INDICATION IN WORKS OF ART

(71) Applicant: Nicolas Courtot, Hillsborough, CA (US)

(72) Inventor: Nicolas Courtot, Hillsborough, CA (US)

(21) Appl. No.: 15/287,330

(22) Filed: Oct. 6, 2016

(51) Int. Cl. G04B 45/00

(52) U.S. Cl. CPC G04B 45/0084

(57) ABSTRACT

An apparatus is disclosed that includes a combination of a time indicator and a work of art. The time indicator matches or blends into the work of art such that an observer may even be unaware, at least at first, that a working clock has been integrated into a work of art. The work of art includes a scene. The scene includes a depiction of a clock at a location within the scene. The apparatus includes a backing having a display side. The work of art is mounted to the display side. The at least one time indicator is positioned over the depiction of the clock at the location within the scene. A clock mechanism is connected to the at least one time indicator to drive a display of time by the at least one time indicator.

### TECHNICAL FIELD

The present disclosure generally relates to interior decorating with clocks and artwork.

### BACKGROUND

Interior decoration or design includes the art and science of enhancing spaces on the interiors (and sometimes even the exteriors) of buildings (e.g., homes or offices), to, for example, achieve a more aesthetically pleasing or more efficient functional environment for users of the spaces. Examples of elements of interior design may include works of art, including aesthetic physical items or artistic creations. The elements may be tangible, portable forms of visual art, including photography, fine art (e.g., a painting, print, drawing, or sculpture), folk art, installation art, conceptual art, or an object designed for aesthetic appeal as well as a functional purpose (e.g., furniture). The particular selection of a combination of such design elements (e.g., by an interior designer) may determine whether people generally consider a space to have or lack aesthetic appeal.

### DESCRIPTION OF THE DRAWINGS

Some embodiments are illustrated by way of example and not limitation in the accompanying drawings, in which:

FIG. 1 is a sketch of an abstraction of a print of a work of art;

FIG. 2 is a sketch of an abstraction of a print of a work of art in which time indicators in a. depiction of a clock included in a scene of the work of art have been removed;

FIG. 3 is a sketch of an abstraction of a print of a work of art in which time indicators in a depiction of a clock included in a scene of the work of art have been removed and in which the clock has been resited and repositioned in the scene;

FIG. 4 is a block diagram of example three-dimensional clock pieces that have been manufactured from three-dimensional models of the clock pieces and that correspond to depictions of the clock pieces in the print of the work of art;

FIG. 5 is a block diagram depicting an apparatus comprising a mounted print of the modified work of art of FIG. 2, the three-dimensional time indicators of FIG. 4, and a clock mechanism to drive a display of time by the three-dimensional time indicators;

FIG. 6 is a block diagram depicting an apparatus comprising a mounted print of the work of art of FIG. 1, the three-dimensional clock face of FIG. 4, the three-dimensional time indicators of FIG.4, and clock mechanism to drive a display of time by the one or more three-dimensional time indicators;

FIG. 7 is a block diagram depicting an apparatus comprising a mounted print of the work of art of FIG. 1, a three-dimensional digital display unit, and a clock mechanism to drive a display of time by the three-dimensional digital display unit;

FIG. 8 is a block diagram of a method of assembling an apparatus in which a functional tune indicator blends into a work of art;

FIG. 9 is a block diagram of an additional method of assembling an apparatus in which a functional time indicator blends into a work of art;

FIG. 10 is a block diagram of an additional method of assembling an apparatus in which a functional time indicator blends into a work of art; and

FIG. 11 is a block diagram of a machine in the form of a computing device that may be included in a clock mechanism and used to drive a display of time by display connected to the clock mechanism.

### DETAILED DESCRIPTION

In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations permutations and combinations of the various features and elements described herein.

In various embodiments, one or more time indicators, such as one or more clock hands or one or more digital numerals displayed on a display unit (and a corresponding clock mechanism that drives the time indicator), are combined with a work of art, such as a print of painting or photograph (famous or not), such that the one or more time indicators not only move as time passes, but also such that the one or more time indicators match, blend into, complement, or are otherwise congruous with the work of art and/or a space into which the work of art is to be placed.

Consistent with one aspect of the inventive subject matter, an apparatus for displaying at least one time indicator within a work of art is disclosed. The work of art includes a substantially two-dimensional representation of a scene. The work of art includes a depiction of a clock at a location within the scene. The apparatus comprises a backing having a display side. The work of art is mounted to the display side. The at least one time indicator is positioned over the depiction of the clock at the location within the scene. A clock mechanism is connected to the at least one time indicator to drive a display of time by the at least one time indicator. The clock mechanism is hidden behind the backing from an angle of viewing of the display side.

Benefits and aspects of the present inventive subject matter will be readily apparent from the description of the figures that follows.

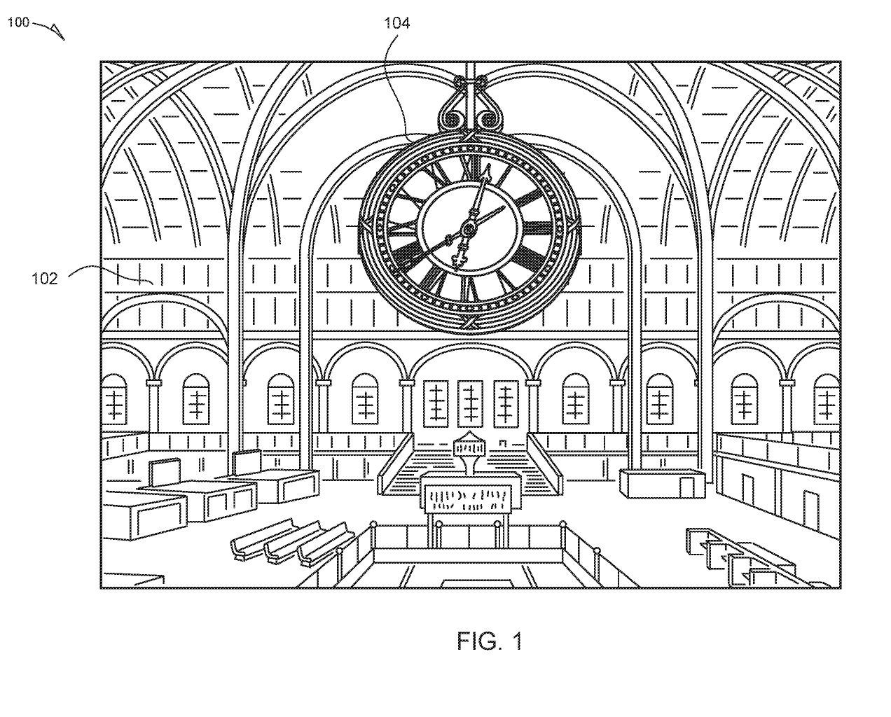

FIG. 1 is a sketch of an abstraction of a work of art 100 in the example form of a photo print. In example embodiments, the work of art 100 is selected based on the work of art including a scene 102 in which a clock 104 is depicted at a location within the scene. In example embodiments, the work of art 100 may be print of a photograph or drawing that includes a scene in which a clock is depicted, such as, for example, Big Ben (London), the clock at the Musee d'Orsay (Paris), the Fifth Avenue clock (New York City), or the clock in the Pennsylvania Station (New York City, 1910-1963).

In example embodiments, the work of art 100 may be a print of a famous photograph or painting, such as, for example, a print of one of the Dogs Playing Poker paintings by Cassius Marcellus Coolidge in which a clock is depicted at a location within the scene. For example, the work of art 100 may be the Sitting Up with a Sick Friend painting (circa 1905) in which a clock is depicted as sitting on a shelf in the background of the scene. Or the work of art 100 may be A Friend in Need (1903) in which a grandfather clock is depicted in the background of the scene.

In example embodiments, the work of art 100 may be a print of a photo of a person carrying a clock (e.g., Flavor Flay of the hip-hop group Public Enemy).

In example embodiments, the work of art 100 may be a print of a photo of a scene of an athletic competition in which a time is displayed on a clock in the background (e.g., on a digital clock face). For example, the photo may be a photo of Roger Federer playing tennis at Wimbledon in which a digital clock is shown on a score board in the background.

In example embodiments, the work of art 100 may be a print of a scene in a film or television series in which a clock is depicted at a location within the scene (e.g., the Hill Valley clock tower lighting scene in the motion picture film Back to the Future (1985).

In example embodiments, the work of art is selected based on principles of interior design, including, for example, unity (e.g., including design elements that complement one another strengthen the whole design composition), balance (e.g., symmetrical balance, assymetrical balance, or radial symmetry within or between design elements), rhythm (e.g., repetition of patterns, colors, textures, or lines between or within design elements); progression (e.g., increasing or decreasing one or more qualities of a design element across multiple design elements); transitions (e.g., providing for a gentle flow of the eye within or between design elements); contrasts (e.g., defining focal points using positive spaces (e.g., colors, furniture, artwork, rugs, flooring) or negative spaces (e.g., voids or empty spaces)); scale (e.g., controlling the size of one design element compared to another), proportion (e.g., controlling the relative size of sub-elements within a design element), or colors.

In example embodiments, the work of art 100 is selected based on the principles of interior design as applied to a space in which the work of art 100 is intended to be placed independent of whether the work of art 100 includes a depiction of a clock at a location within a scene of the work of art 100.

In example embodiments, a digital representation of the work of art is purchased, licensed (e.g., Getty Images or the artist) and received at a device. In example embodiments, a digital representation of the work of art is captured via a device (e.g., a digital camera or mobile phone) or scanned in (e.g., using a scanner on an original work of art). In example embodiments, the work of art is created (e.g., sketched or painted) for digital capture or created via a device (e.g., via graphic design software). In example embodiments, the digital representation is digitally stored in a storage medium such that the digital representation can be accessed by an editing computer system (e.g., via a network connection).

In example embodiments, a digital representation from which the print is generated is received or accessed at an editing computer system. In example embodiments, the digital representation is modified (e.g., using digital image editing software on the editing computer system) such that a resulting print better satisfies one or more design principles for a space in which the print is to be placed. For example, an aspect of the digital representation, such as a size or shape of the work of art or colors used within the work of art, is modified. Such modifications may include modifications of aspects of individual things depicted within a scene of the work of art. For example, one or more time indicators included in a depiction of a clock that is included at a location in a scene of the work of art is digitally removed from the depiction of the clock. As another example, a proportion of the clock depiction may be modified relative to the scene in which it is depicted (e.g., such that the clock depiction better satisfies a principle of interior design pertaining to a space into which the work of art is intended to be placed or so that a time indicator that is to be placed over the clock depiction matches the size of the clock depiction, as described in more detail below). As another example, a depiction of a clock may be digitally inserted into the digital representation of the scene of the work of art (e.g., as a background element of the scene) at a location where no clock depiction existed in the original work of art. The size, shape, colors, and proportion of the new clock depiction may be based on one or more characteristics of the work of art itself (e.g., a theme of the work of art) or a principle of interior design pertaining to a space in which the work of art is intended to be placed. In example embodiments, the proportion or size of the new clock depiction inserted into the digital representation of the work of art may be chosen based on a size of a time indicator that is to be placed over the clock depiction, as described in more detail below.

In example embodiments, the work of art 100 is a print of an original work of art (e.g., a famous painting or photograph) having the same scale as the original work of art. Alternatively, the work of art 100 is a print having a different scale than the original work of art on which it is based. In example embodiments, the different scale is selected based on principles of interior design as applied to a space in which the work of art 100 is intended to be placed.

In example embodiments, the digital representation is communicated to a printing device for printing. The resulting print is then mounted onto a backing on a display side of the backing. Examples of backings include bamboo, matboard, foamcore, gatorboard, styrene, posterboard, and so on.

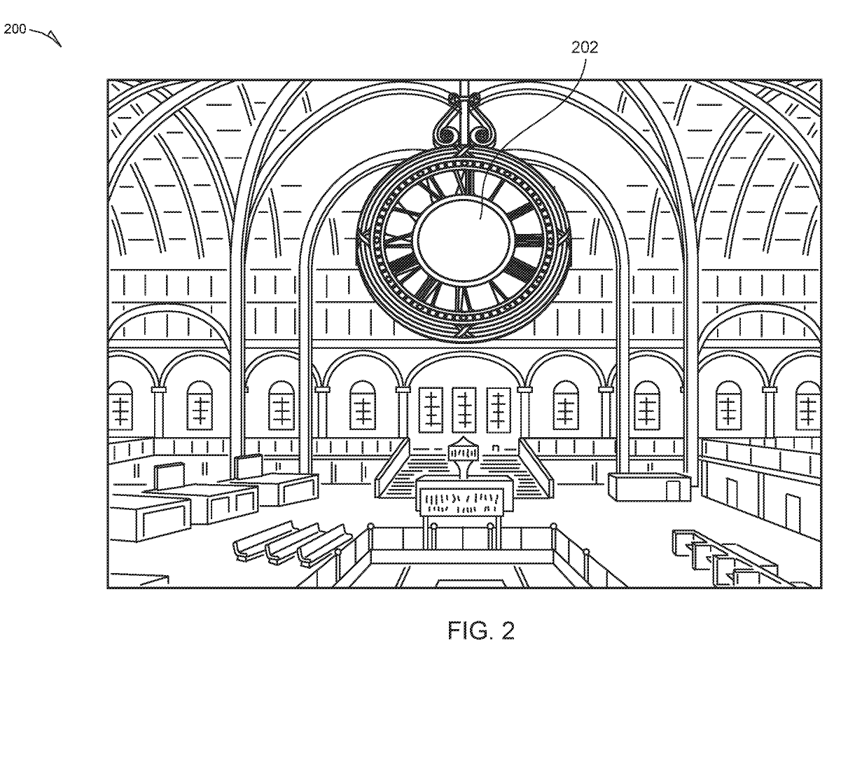

FIG. 2 is a sketch of an abstraction of a print of a work of art in which time indicators in a depiction of a clock 202 included in a scene of the work of art have been removed.

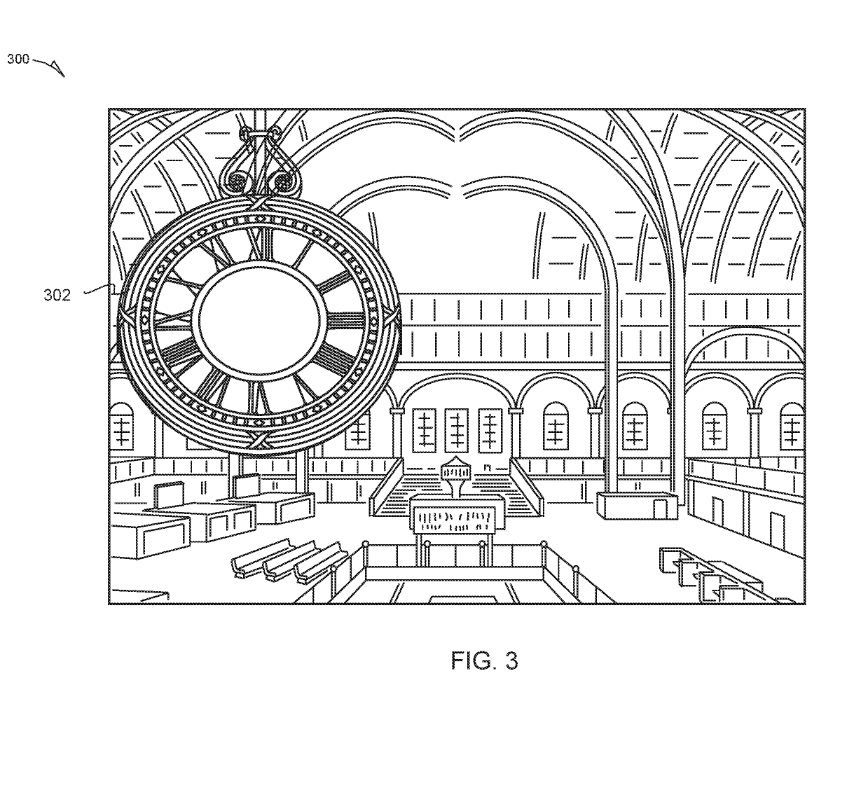

Additionally, FIG. 3 is a sketch of an abstraction of a print of a work of art in which time indicators in a depiction of a clock 302 included in a scene of the work of art. have been removed and in which the clock has been resized and repositioned in the scene.

In example embodiments, one or more three-dimensional models of one or more three-dimensional time indicators are created (e.g., at the editing computer system using 3-D modelling or 3-D printing software applications). The one or more three-dimensional time indicators are modelled such that they may be placed over the print at the location of the clock depiction in the scene of print, as described in more detail below. In example embodiments, each of the three-dimensional time indicator models is a digital representation of a replica of one of respective time indicators depicted in the clock depiction of the digital representation of the work of art. For example, the scale and proportion of the three-dimensional time indicators may be selected based on the scale and proportion of the clock depiction in the original work of art or the modified digital representation of the clock depiction corresponding to the print that is based on the original work of art.

In example embodiments, one or more three-dimensional models of one or more three-dimensional clock faces corresponding to one or more clock faces in the clock depictions of the work of art are created (e.g., at the editing computer system using 3-D modelling or 3-D printing software applications). The one or more clock faces are modelled such that they may be placed over the print at the location of one or more corresponding clock faces in the clock depictions of the work of art. In example embodiments, each of the three-dimensional clock face models is a digital representation of a replica of a clock face depicted in the clock depiction of the digital representation of the work of art. For example, the scale and proportion of the three-dimensional clock face may be selected based on the scale and proportion of the clock face to the clock depiction in the original work of art or the modified digital representation of the clock face depiction corresponding to the print that is based on the original work of art. In example embodiments, the three-dimensional time indicator or clock face models may be based on actual schematics of the actual clocks depicted in the work of art.

In example embodiments, the one or more three-dimensional models are communicated for printing at a three-dimensional printing device or for generating of a mold for molding of the one or more three-dimensional time indicators. In example embodiments, the three-dimensional time indicators resulting from the 3D-printing or molding processes may be modified (e.g., sculpted, sanded, painted, and so on) to more accurately replicate in real life the time indicators depicted in the clock depiction of the original work of art (e.g., at a scale or proportion relative to the clock depiction).

In example embodiments, each of the one or more three-dimensional time indicators are placed over the print at the location of the depiction of the clock within the scene and connected to a clock mechanism. For example, a hole may be created through the backing at the center of the clock depiction. One or more shafts of the clock mechanism (e.g., the shafts of the seconds wheel, minute wheel, or hour wheel of the clock mechanism) may then be inserted into the hole from behind the backing for connecting to the corresponding three-dimensional time indicators (e.g., a seconds hand, a minutes hand, or an hour hand). The clock mechanism may be, for example, an electric clock motor, a quartz clock movement, an atomic clock movement, a mechanical (e.g., spring-driven) clock movement, a weight-driven clock movement, a watch clock movement, and so on. The clock mechanism may be selected based on the scale or size of the print or the scale or size of the clock depiction at the location of the scene depicted in the print. In example embodiments, the clock mechanism is selected and positioned such that it may be substantially hidden (e.g., except for a portion of its shafts that are protruding through the hole) from an angle of viewing of the display side of the backing on which the print is mounted.

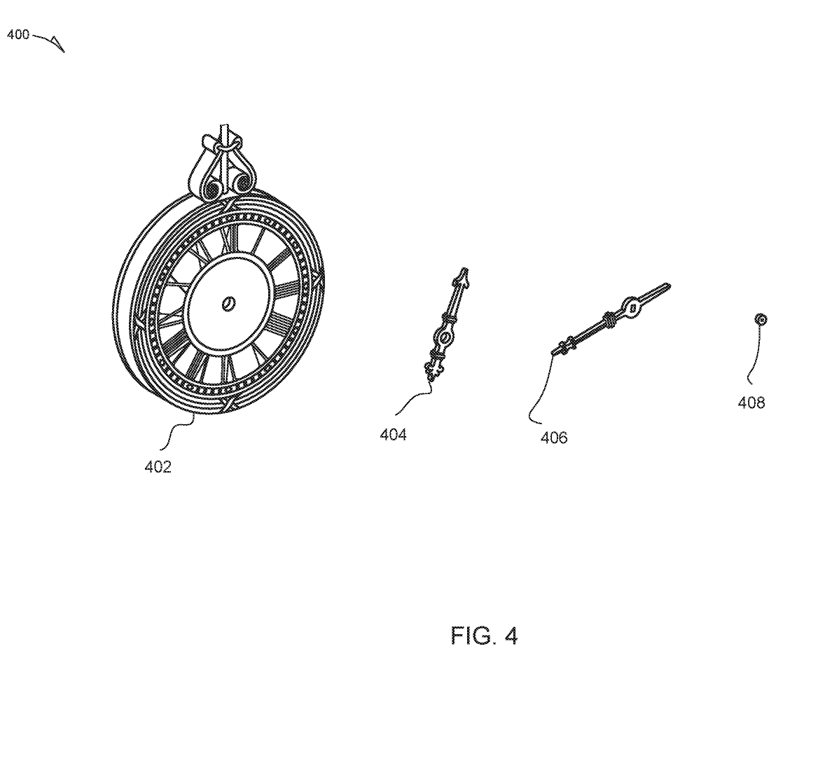

FIG. 4 is a block diagram of example three-dimensional clock pieces 400 that have been manufactured from three-dimensional models of the clock pieces and that correspond to depictions of the clock pieces in the print of the work of art. The depicted clock pieces 400 include a clock face 402, an hour hand 404, a minute hand 406, and a cap 408. Of course, in example embodiments, there may be additional clock pieces (not shown), such as a seconds hand or another clock piece, such as a clock piece that is part of an actual clock (e.g., past or present) that is being replicated.

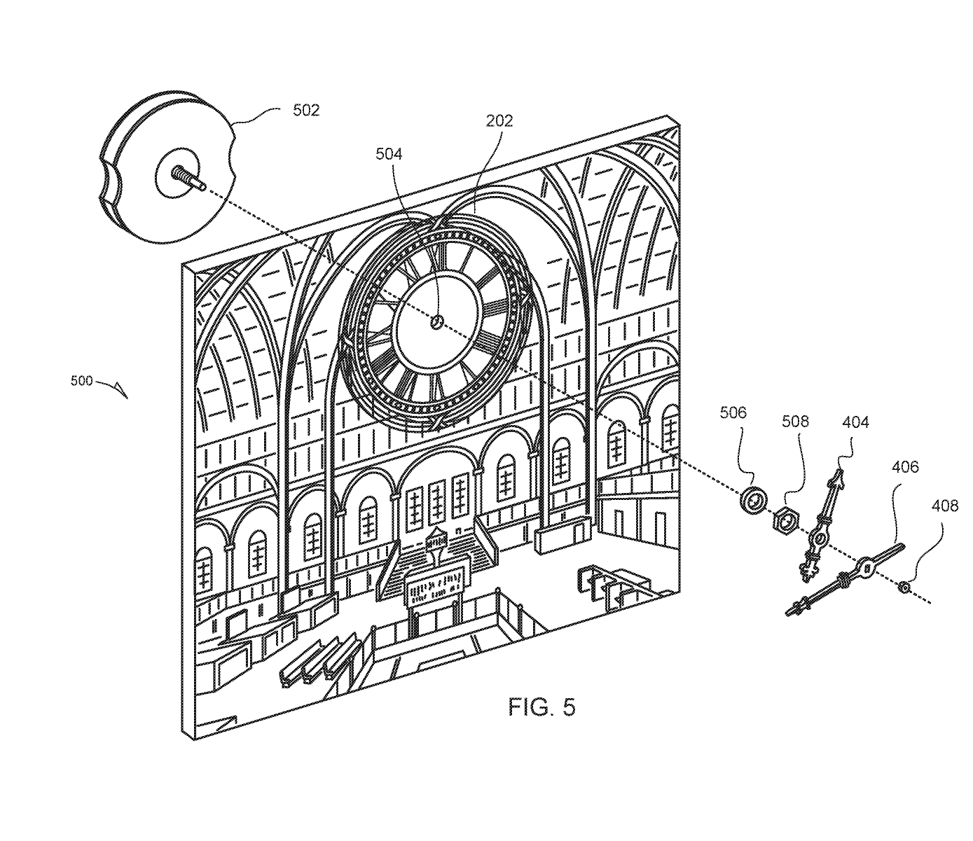

FIG. 5 is a block diagram depicting an apparatus comprising a mounted print of the modified work of art of FIG. 2, the three-dimensional time indicators of FIG. 4, and a clock mechanism to drive a display of time by the three-dimensional time indicators.

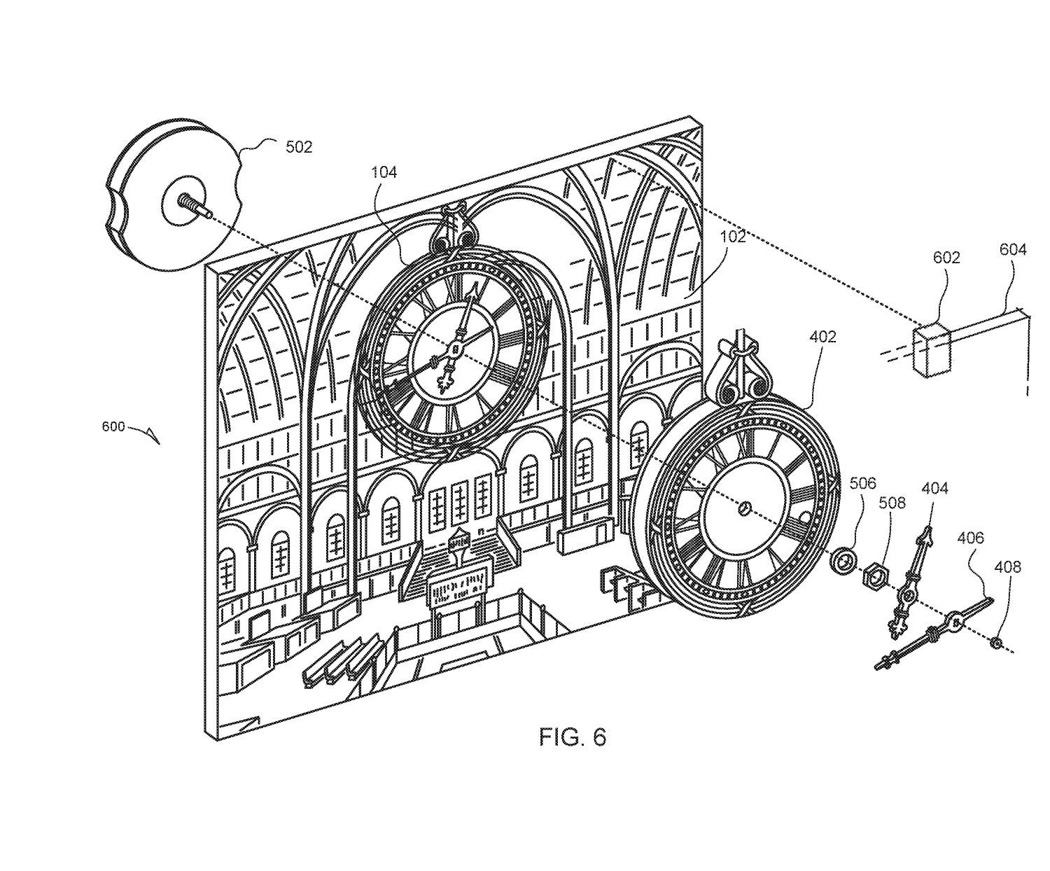

FIG. 6 is a block diagram depicting an apparatus comprising a mounted print of the work of art of FIG. 1, the three-dimensional clock face of FIG. 4, the three-dimensional time indicators of FIG.4, and clock mechanism to drive a display of time by the one or more three-dimensional time indicators. In example embodiments, one or more of the three-dimensional clock pieces may be at least partially inset into the backing (e.g., into a carved space in the backing at the location of the clock depiction, the carved space providing a tight fighting for the at least partial insertion of a clock piece into the backing). In example embodiments, the clock pieces may be inset into the backing such that one or more of the clock pieces, such as clock face 402, is flush with the display side. In example embodiments, one or more three-dimensional separator pieces, such as mat boards or spacers, may be affixed to the display side. The height of the separator pieces may be selected such that any glass or glazing placed over the display side contacts the separator pieces instead of the working clock pieces, such as the three-dimensional time indicators, or otherwise ensures that framing of the work of art does not interfere with the operation of the clock.

In example embodiments, the clock pieces are three-dimensional replicas of actual clock pieces corresponding to an actual clock (e.g., past or present, famous or not) that is included in the work of art (e.g., based on schematics of the actual clock pieces of the actual clock). In other embodiments, the clock pieces are three-dimensional replicas of clock pieces as they are depicted within the work of art. in example embodiments, the work of art with the integrated clock is not merely a functional wall clock with a clock face having some artistic elements or style; instead it is an independent work of art, designed specifically for its aesthetic or emotional appeal, that stands alone as a work of art whether or not the time indicator is integrated into it. As such, an observer of the work of art may be struck by the verisimilitude of the working clock that has been integrated into the work of art or may even be unaware, at least at first, that a working clock has been integrated into the work of art. In this way, a work of art that has been selected for a particular space (e.g., based on design principles) may be enhanced with a functional purpose. Thus, an interior space may be designed for aesthetic appeal without at least some constraints related to providing users of the space with the convenience of being able to determine the accurate time.

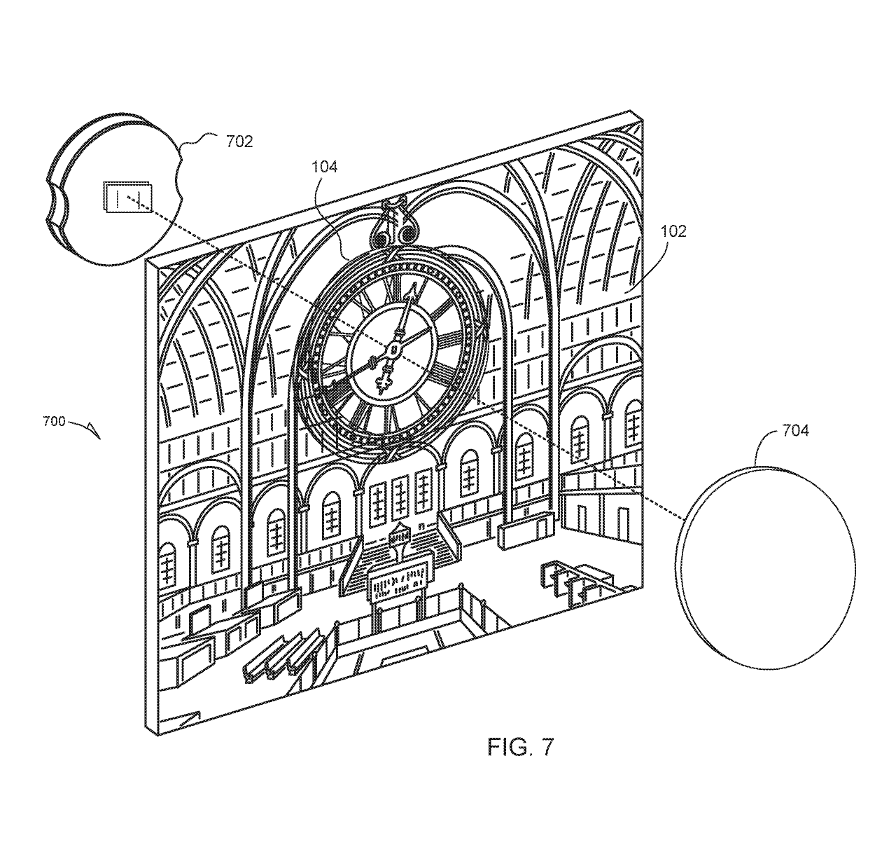

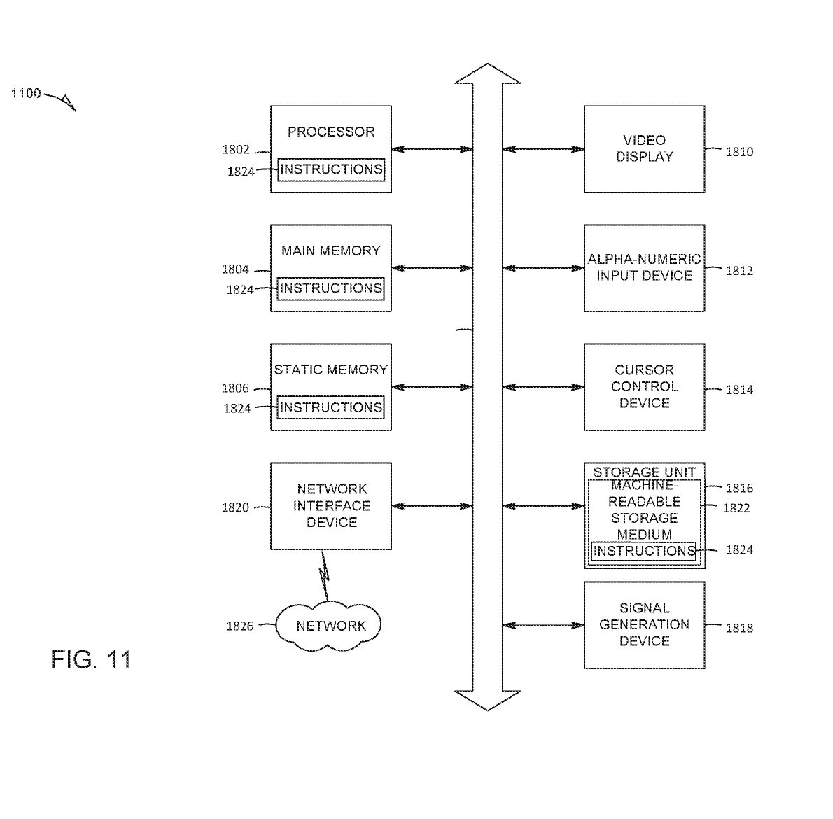

FIG. 7 is a block diagram depicting an apparatus comprising a mounted print of the work of art of FIG. 1, a three-dimensional display unit 704 and a clock mechanism 702 to drive a display of time by the three-dimensional digital display unit 704. In example embodiments, the clock mechanism 702 is electronically coupled to the three-dimensional display unit. In example embodiments, the clock mechanism 702 and display unit 704 are integrated together (e.g., as a. single piece). In example embodiments, the clock mechanism 702 and display unit 704 may be embedded into the backing (e.g., such that the display unit 704 is flush with the display side. In example embodiments, the clock mechanism 702 and display unit 704 comprise a computing system such as the computing system depicted in FIG. 11. Instructions included in a memory of the computing system may control a display of time on the display unit 704. For example, the instructions may be embodied in a software application executing on the computing system. In example embodiments, the instructions may control the display such that the display unit blends into a scene depicted in the work of art. For example, the instructions may cause a digital reproduction of a portion of the work of art over which the display unit 704 is placed such that the edges of the display unit 704 are camouflaged within the work of art. For example, the edges of the display unit 704 itself may not be readily discernible to an observer of the work of art because the image depicted on the display unit matches the scene into which the display unit is placed. In example embodiments, the instructions may control the display unit to reproduce a clock depiction or replicate an actual clock (e.g., past or present) that is depicted in the work of art, but control the reproduction such that the clock always shows the current time (e.g., as determined through synchronization with a computer time server or service, such as a network time protocol (NTP) server).

In example embodiments, a computing system comprising the digital display unit 704 and the clock mechanism 702 may be coupled to one or more sensors, such as light sensors. In example embodiments, the instructions controlling the display of time on the display unit 704 may control the brightness and contrast of the display unit based on the amount of light sensed by the light sensors. Thus, for example, a clock face depicted by the display unit may be brightened when the work of art is bathed in brighter light (e.g., sunlight or artificial light) and dimmed when the work of art is bathed in less light, or vice versa.

In example embodiments, an image displayed on the display unit may replicate a portion of the work of art that is obscured by a placing of the computing system over the work of art or by an embedding of the computer system within the work of art. Thus, for example, if the display unit is detectable by a viewer it all, it may simply appear to the viewer to be a clear glass surface placed over the work of art. in addition to replicating the portion of the art over which the display unit is placed, the display of time within the display unit is updated as time moves. In example embodiments, rather than replacing merely a portion of the work of art over which it is placed, the image displayed on the display unit (or projected by a projecting unit, as described below) may comprise the entire the work of art. The image would appear to the viewer to be the work of art and the movement of the time indicator within the work of art would be seamless to the viewer, but would reflect the current time.

In example embodiments, the computing system may be coupled to one or more image projectors. In example embodiments, the one or more projectors may be used in addition to or as an alternative to the display unit. In example embodiments, the one or more projectors may project an image over the work of art, the image including one more time indicators such that actual movement of time included in the image is depicted within the work of art.

In example embodiments, the image projection or display may advantageously show movement of time within a work of art in which the clock depicted within the scene has a viewing perspective that is not perpendicular to the viewing angle of the viewer. In other words, a clock that is depicted within the scene as being at an angle (e.g., as opposed to directly facing the viewer) may nevertheless be depicted through the image projection or display as having moving clock pieces that are appropriately adjusted for the perspective as time moves. Thus, for example, the hands of the depicted clock may get smaller as they move to a side of the clock face that is depicted as being farther from the viewer and bigger as they move to the side of the clock fact that is depicted as being closer to the viewer. Thus, a work of art that originally depicted a clock having one or more time indicators fixed at a particular position may be bought to life within the display such that digital replicas of the time indicators move within a context and viewing angle of the depiction of the clock within the scene of the work of art.

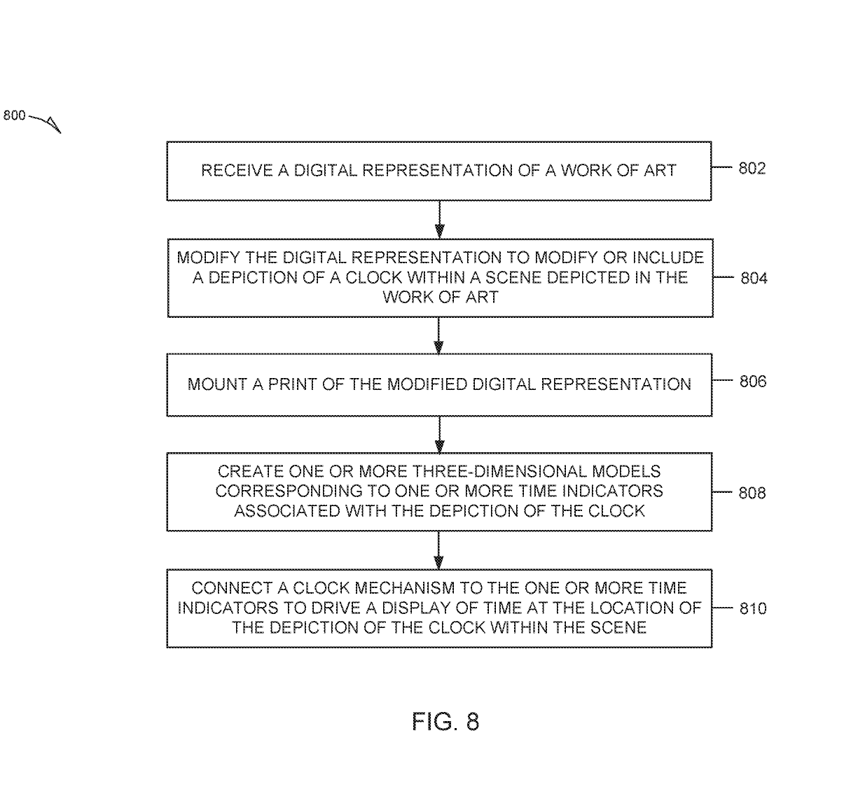

FIG. 8 is a block diagram of a method of assembling an apparatus in which a functional time indicator blends into a work of art. At step 802, a digital representation of a work of art is received (e.g., at an editing computer system). At step 804, the digital representation is modified to include or modify a depiction of a clock within a scene depicted in the work of art. At step 806, a print of the modified digital representation is mounted. At step 808, one or more three-dimensional models are created. The one or more three-dimensional models correspond to one or more time indicators included in the depiction of the clock. At step 810, a clock mechanism is connected to the one or more time indicators to drive a display of time at the location of the depiction of the clock within the scene.

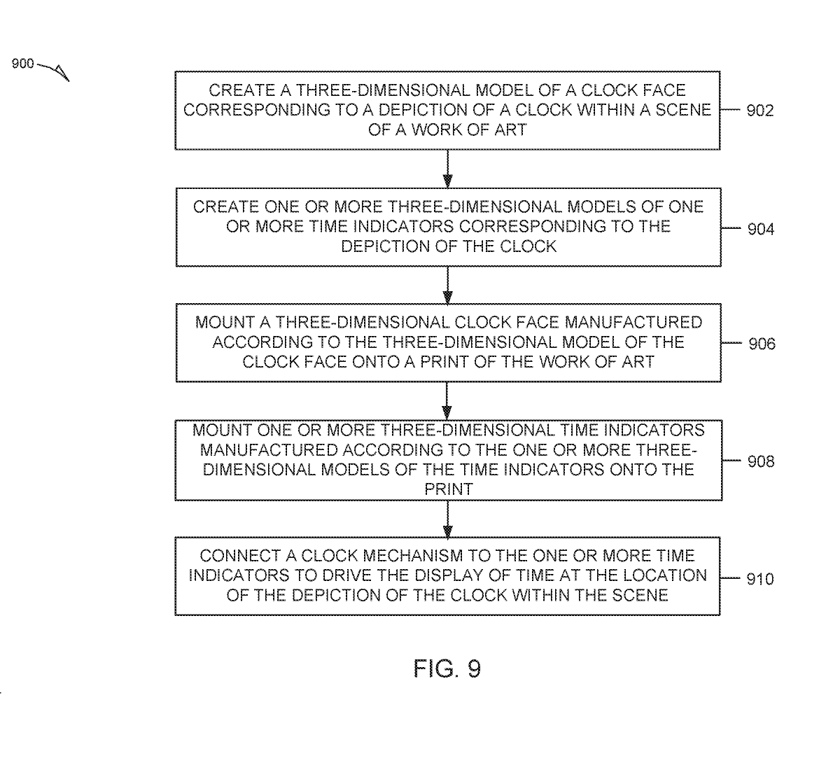

FIG. 9 is a block diagram of an additional method of assembling an apparatus in which a functional time indicator blends into a work of art. At step 902, a three-dimensional model of a clock face is created. The model of the clock face corresponds to a depiction of a clock within a scene of a work of art. At step 904, one or more three-dimensional models of one or more time indicators are created. The models of the time indicators correspond to time indicators included in the depiction of the clock. At step 906, a three-dimensional clock face manufactured according to the model of the three-dimensional clock face is mounted to a print of the work of art. At step 908, one or more three-dimensional time indicators manufactured according to the models of the three-dimensional time indicators are mounted to the print. At step 910, a clock mechanism is connected to the one or more time indicators to drive the display of time with respect to the three-dimensional clock face at the location of the depiction of the clock within the scene. In example embodiments, one or more of the clock pieces may be comprised of glowing materials and/or one or more glowing materials may be attached to the one or more clock pieces such that the one or more clock pieces can be seen in low-light conditions. Thus, a viewer of the artwork may be able to determine the time even when it is too dark to view the work of art clearly. In example embodiments, a power source (e.g., a battery or other electrical source) may be coupled to one or more lighting apparatuses, such as LED lights. The lighting apparatuses may be coupled to one or more clock pieces, a frame surrounding the work of art, a glass or glazed surface behind which the work of art is place, or the work of art itself such that the display of time within the work of art may be specifically illuminated. In example embodiments, the light apparatuses may be dimmable by a switch. In example embodiments, the switch may be placed at an easily-accessible location, such as at the edge of a frame surrounding the work of art. In example embodiments, the switch may be placed unobtrusively, such as embedded within the frame and/or made flush with the edge of the frame, such that a viewer of the work of art would not know the switch was there unless the viewer had previous knowledge of it or was specifically directed to it). In example embodiments, the lighting apparatuses may be dimmable automatically by a computing system (e.g., based on an amount of light detected by lighting sensors, as described above). In example embodiments, a power source of the clock mechanism may be tapped (e.g., via electrical circuitry or wiring) to supply power to the light apparatuses or sensors such that an additional power source is not needed. In example embodiments, the lighting apparatuses may illuminate the display of time using colors that complement the work of art. facilitate a blending in of the time indicator into the work of art, or improve an aesthetic appeal of the work of art (e.g., based on principles of interior design with respect to the space in which the work of art is to be placed). In example embodiments, the lighting apparatuses may be placed (e.g., on the work of art, a frame surrounding the work of art, or on a glass surface behind which the work of art is placed) such that they provide backlighting for one or more time indicators or clock pieces or the lighting apparatuses may be placed such that they serve to provide one or more spotlights on the one or more time indicators or clock pieces.

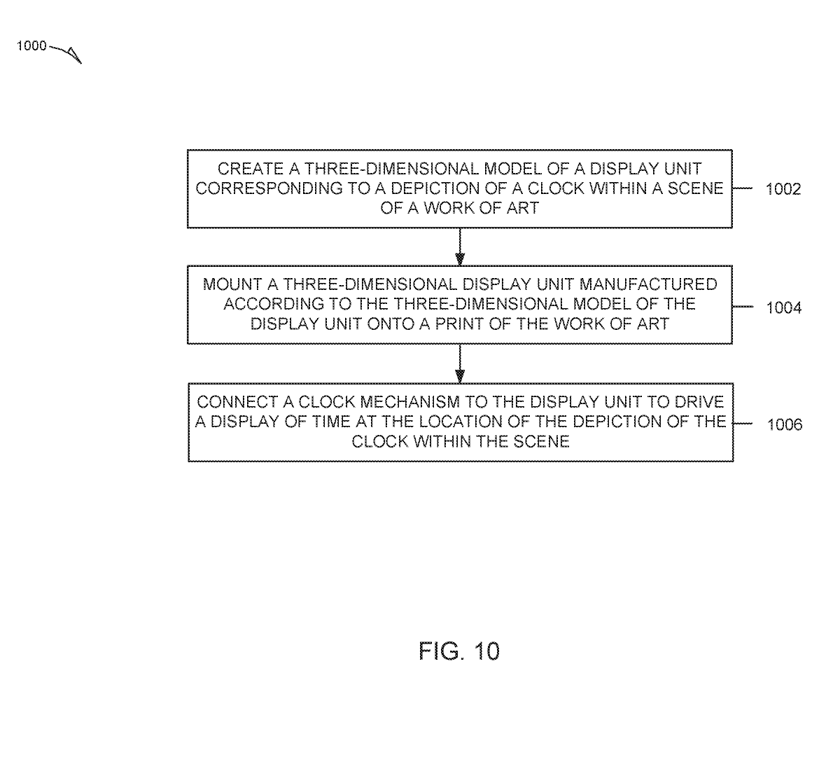

FIG. 10 is a block diagram of an additional method of assembling an apparatus in which a functional time indicator blends into a work of art. At step 1002, a three-dimensional model of a display unit corresponding to a depiction of a clock within a scene of a work of art is created. At step 1004, a three-dimensional display unit manufactured according to the three-dimensional model of the display unit is mounted onto a print of the work of art. At step 1006, a clock mechanism is connected to the display unit to drive a display of time at the location of the depiction of the clock within the scene.

FIG. 11 is a block diagram of a machine in the form of a computing device. Examples of computer devices may be an editing computer system used to manage digital representations of works of art or a display-unit-customization computer system (e.g., included in a clock mechanism and used to drive a display of time by display unit connected to the clock mechanism). While only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g,, a central processing unit (CPU), a graphics processing unit (GPU) or both), a main memory 1804 and a static memory 1806, which communicate with each other via a bus 1808. The computer system 1800 may further include a video display unit 1810 (e.g., a liquid crystal display (LCD), a cathode ray tube (CRT), an organic light-emitting diode (OLED) display, and so on). The computer system 1800 may be configured to connect to an alphanumeric input device 1812 (e.g., a keyboard), a user interface (UI) navigation (or cursor control) device 1814 (e.g., a mouse), a storage unit 1816, a signal generation device 1818 (e.g., a speaker), a network interface device 1820. The computer system 1800 may include or be coupled to one or more sensors, one or more light apparatuses, or one or more power sources, as described above.

The storage unit 1816 includes a machine-readable medium 1822 on which is stored one or more sets of data structures and instructions 1824 (e.g., software) embodying or utilized by any one or more of the methodologies or functions described herein. The instructions 1824 may also reside, completely or at least partially, within the main memory 1804 and/or within the processor 1802 during execution thereof by the computer system 1800, the main memory 1804 and the processor 1802 also constituting machine-readable media. The instructions 1824 may also reside, completely or at least partially, within the static memory 1806.

While the machine-readable medium 1822 is shown in an example embodiment to be a single medium, the term “machine-readable medium” may include a single medium or multiple media (e.g., a centralized or distributed database, and/or associated caches and servers) that store the one or more instructions 1824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

Accordingly, a “tangible machine-readable medium” may refer to a single storage apparatus or device, as well as “cloud-based” storage systems or storage networks that include multiple storage apparatus or devices. Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 1824 may further be transmitted or received over a communications network 1826 using a transmission medium. The instructions 1824 may be transmitted using the network interface device 1820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 1826 may be one of the networks 104.

Thus, in example embodiments, one or more time indicators are combined with a work of art, such as a print of photograph or painting, such that the time indicators not only moves as time passes, but also such that the time indicators match or blend into or complement the work of art.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. An apparatus comprising:
a backing having a display side;
a work of art mounted to the display side of the backing, the work of art including a modified photograph of a scene, the modified photograph differing from an original photograph in that a time indicator forming part of a physical clock that was captured in the original photograph is absent from the modified photograph;
a replicated time indicator integrated into the work of art the replicated time indicator being a three-dimensional time indicator matching the time indicator that was captured in the original photograph in size and in scale, the replicated time indicator being movable to change a current time in combination with the modified photograph; and
a clock mechanism connected to the replicated time indicator to drive a display of time by the replicated time indicator, the replicated time indicator being visible when the work of art is viewed from the display side, wherein the display of time is non-conspicuous within the work of art and has verisimilitude to an observer of the work of art.

2.-5. (canceled)

6. The apparatus of claim 1, wherein the modified photograph further differs from the original photograph in that the physical clock has been repositioned within the modified photograph relative to the original photograph.

7. A method of assembling a clock, the method comprising:
receiving a first digital representation of a work of art, the first digital representation including a depiction of a scene, the depiction of the scene including a depiction of a clock, the depiction of the clock including a depiction of a time indicator, the depiction of the clock corresponding to a physical clock;
generating a second digital representation of the work of art based on the first digital representation, the generating of the second digital representation including digitally removing the depiction of the time indicator relative to the first digital representation;
creating a print of the second digital representation of the work of art;
creating a replicated time indicator the creating of the replicated time indicator including producing, based on a three-dimensional model derived from one or more schematics corresponding to the physical clock, a three-dimensional physical time indicator, the producing of the three-dimensional physical time indicator including editing the three-dimensional model such that the three-dimensional physical is scaled to a proportion of the depiction of the clock;
integrating the replicated time indicator into the work of art,
mounting the print to a backing;
connecting a clock mechanism to the replicated time indicator through the backing, the clock mechanism configured to drive a display of time by the replicated time indicator, wherein the display of time is non-conspicuous within the work of art and has verisimilitude to an observer of the work of art.

8. A kit of parts for blending a functional time piece into a print of a work of art mounted on a backing, the kit comprising:
a clock mechanism configured to be attached to the backing on a side opposite to a display side of the backing, the clock mechanism having a shaft that is configured to be inserted through the backing, the length of the shaft sized based on a thickness of the backing and a height of one or more separator pieces separating the backing from a glazing placed over the display side such that a framing of the work of art does not interfere with the operation of the clock mechanism; and
one or more replica clock pieces, the one or more replica clock pieces being replicas of one or more original clock pieces of a physical clock, a depiction of the physical clock being included in a modified digital image from which the print was generated, the modified digital image differing from a captured digital image in that depictions of the one or more clock pieces are removed from the depiction of the physical clock relative to the original digital image, the one or more replica clock pieces created to, based on an editing of a three-dimensional model derived from one or more schematics corresponding to the physical clock, integrated into the print, the one or more replica clock pieces further configured to be attached to the shaft such that the one or more replica clock pieces are visible when the print of the work of art is viewed from the display side, the editing including sizing the three-dimensional model based on the dimensions of the depiction of the physical clock in the modified digital image, the clock mechanism configured to drive a display of time by the one or more replica clock pieces, wherein the display of time is non-conspicuous within the work of art and has verisimilitude to an observer of the work of art.

9. The apparatus of claim 1, wherein the physical clock is the Pennsylvania Station clock or another clock that was captured in the original photograph but that no longer exists.

10. The apparatus of claim 1, wherein the physical clock is part of a public building that was captured in the original photograph.

11. The apparatus of claim 1, wherein the physical clock is one of the Musee d'Orsay clock or the Fifth Avenue clock.

12. The method of claim 7, wherein the display of time is non-conspicuous based at least in part on a color associated with the work of art being incorporated into the replicated time indicator.

13. The method of claim 7, wherein the generating of the second digital representation of the work of art further comprises repositioning the depiction of the clock relative to the first digital representation based on an interior design principle pertaining to a space in which the print is intended to be placed, the interior design principle pertaining to at least one of balance, transitions, or contrasts of the print with respect to the space.

14. (canceled)

15. (canceled)

16. The method of claim 7, wherein the generating of the second digital representation further includes filling in details of the depiction of the clock that are removed upon the removing of the depiction of the time indicator.

17. (canceled)

18. The apparatus of claim 1, wherein the display of time has the verisimilitude based at least in part on an accuracy of the display of time.

19. The apparatus of claim 18, wherein the display of time has the verisimilitude based at least in part on a viewing perspective of the physical clock included in the modified photograph being perpendicular to the viewing angle of the observer.

20. The apparatus of claim 1, wherein the display of time has the verisimilitude based at least in part on a shape of the replicated time indicator matching a shape of the time indicator that was captured in the original photograph.

21. The apparatus of claim 1, wherein the display of time is non-conspicuous based at least in part on a thematic characteristic of the work of art being incorporated into the replicated time indicator such that the replicated time indicator blends into the work of art.
